(19) United States
(12) Patent Application Publication
(10) Pub. No.: US 2008/0256966 A1
(43) Pub. Date: Oct. 23, 2008

(54) Vehicular air conditioner

(75) Inventors: Masafumi Kawashima, Kariya-city (JP); Tatsumi Kumada, Gamagori-city (JP); Takuya Kataoka, Okazaki-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/998,365

(22) Filed: Nov. 29, 2007

(30) Foreign Application Priority Data
Dec. 15, 2006 (JP) 2006-339222

(51) Int. Cl. B60H 1/32

(52) U.S. Cl. 62/239

(57) ABSTRACT

An air conditioner for a vehicle includes a blower for generating a flow of air, a center defroster air-blowing outlet disposed adjacent to a windshield of the vehicle for blowing the air toward the windshield, a side defroster air-blowing outlet disposed adjacent to a side window glass of the vehicle for blowing the air toward the side window glass, and a defroster air volume adjusting unit disposed to adjust the volume of air blown from a center defroster air-blowing outlet and the volume of air blown from a side defroster air-blowing outlet.

### CROSS REFERENCE TO RELATED APPLICATION

This application is based on Japanese Patent Applications No. 2006-339222 filed on Dec. 15, 2006, the disclosure of which is incorporated herein by reference.

### FIELD OF THE INVENTION

The present invention relates to an air conditioner for a vehicle.

### BACKGROUND OF THE INVENTION

For example, when the temperature of air outside of a passenger compartment of a vehicle is extremely low, such as in winter, window glasses of the vehicles are chilled due to the cool outside air. Thus, even during a heating operation of an air conditioner, air inside of the passenger compartment, such as air adjacent to the cold window glasses will be cooled by the chilled window glasses and flows downwardly. The flow of the cooled air is, for example, referred to as cold draft. A passenger will have a chill, for example, in his shoulders, back, knees, and the like due to the cold draft.

To solve the cold draft, Japanese Unexamined Patent Publication No. 11-105542 describes to mount an actuator such as a motor in a side face air-blowing outlet for aligning a flow direction of air passing through the side face air-blowing outlet toward a side window glass. However, mounting the actuator increases costs. Also, the side face air-blowing outlet is provided with a member such as louvers so that the side face air-blowing outlet can be opened and closed. Therefore, when the side face air-blowing outlet is closed, it is difficult to provide the effect of reducing the cold draft.

Japanese Unexamined Patent Publication No. 11-208242 describes a structure that blows heated air from a floor toward a ceiling for reducing the cold draft. The disclosed structure may be effective to a passenger's lower body such as his back and knees, but may be in sufficient to introduce the heated air to a passenger's upper body. If the volume of the heated air is increased, dusts will be flung up.

Japanese Unexamined Patent Publications No. 2002-67662, No. 2006-69269 and No. 2006-290221 propose to mount a rear air conditioning unit for solving the cold draft around a rear seat area. Also, Japanese Unexamined Patent Publication No. 2004-338512 proposes an air conditioning unit for performing a heating operation for a large vehicle such as a bus or a train for solving the cold draft.

### SUMMARY OF THE INVENTION

It is an object of the present invention to provide an air conditioner for a vehicle capable of reducing or dissolving the cold draft.

According to an aspect of the present invention, an air conditioner for a vehicle includes a blower for generating a flow of air, a center defroster air-blowing outlet for blowing the air toward the windshield, a side defroster air-blowing outlet for blowing the air toward the side window glass of the vehicle, and a defroster air volume adjusting unit disposed to adjust the volume of air blown from the center defroster air-blowing outlet and the side defroster air-blowing outlet.

Accordingly, since the volume of air blown from the side defroster air-blowing outlet is adjusted, cold draft due to a chilled window glass such as the windshield and/or the side window glass is effectively swept or reduced.

According to another aspect of the present invention, an air conditioner for a vehicle includes a blower for generating a flow of air, an air conditioning case defining an air passage through which the air generated by the blower flows and including a defroster opening portion that allows the air to pass through, a defroster duct coupled to the defroster opening portion, and a defroster air volume adjusting unit. A center defroster air-blowing outlet is disposed adjacent to a windshield of the vehicle for blowing the air passing through the defroster opening portion toward the windshield. A side defroster air-blowing outlet is disposed adjacent to a side window glass of the vehicle for blowing the air passing through the defroster opening portion toward the side window glass. The defroster duct includes a center defroster passage portion that allows communication between the defroster opening portion and the center defroster air-blowing outlet and a side defroster passage portion that allows communication between the defroster opening portion and the side defroster air-bowing outlet. The defroster air volume adjusting unit is configured to adjust a volume of air passing through the center defroster passage portion separately from a volume of air passing through the side defroster passage portion.

Accordingly, the volume of air blown from the center defroster air-blowing outlet and the volume of air blown from the side defroster air-blowing outlet are separately adjustable. As such, cold draft due to a chilled window glass such as the windshield and/or the side window glass is effectively swept or reduced.

For example, the defroster air volume adjusting unit includes a center defroster door device that is capable of adjusting the volume of air passing through the center defroster duct portion and a side defroster door device that is capable of adjusting the volume of air passing through the side defroster duct portion. The center defroster door device and the side defroster door device are, for example, separately operated according to a temperature of at least one of the windshield and the side window glass, which may be detected by a temperature detecting unit.

### BRIEF DESCRIPTION OF THE DRAWINGS

Other objects, features and advantages of the present invention will become more apparent from the following detailed description made with reference to the accompanying drawings, in which like parts are designated by like reference numbers and in which:

FIG. 1 is a schematic diagram of an air conditioner for a vehicle according to a first embodiment of the present invention;

FIG. 2 is a schematic view of a part of a passenger compartment of the vehicle for showing locations of air-blowing outlets according to the first embodiment;

FIG. 3 is a schematic exploded view of a defroster section of the air conditioner according to the first embodiment;

FIG. 4 is a perspective view of door devices of the defroster section according to the first embodiment;

FIG. 5 is a pattern diagram showing a relationship between air-blowing modes and doors of the air conditioner according to the first embodiment;

FIG. 6 is a schematic exploded view of slide doors of a defroster section of an air conditioner for a vehicle according to a second embodiment of the present invention;

FIG. 7 is a pattern diagram showing a relationship between air-blowing modes and doors according to the second embodiment;

FIG. 8 is a schematic exploded view of slide doors of a defroster section of an air conditioner for a vehicle according to a third embodiment of the present invention;

FIG. 9 is a schematic exploded view of a slide door of a defroster section of an air conditioner for a vehicle according to a fourth embodiment of the present invention;

FIG. 10 is a cross-sectional view of a defroster section of an air conditioner for a vehicle according to a fifth embodiment of the present invention;

FIG. 11 is a cross-sectional view of a defroster section of an air conditioner for a vehicle according to a sixth embodiment of the present invention; and

FIG. 12 is a schematic view of a part of a passenger compartment of a vehicle for showing arrangement of door ducts of an air conditioner according to a seventh embodiment of the present invention.

### DETAILED DESCRIPTION OF EXEMPLARY EMBODIMENTS

Hereafter, first to seventh embodiments of the present invention will be described with reference to the accompanying drawings. In the second to seventh embodiments, components similar to those of the first embodiment will be indicated by the same numerals and will not be described further.

### First Embodiment

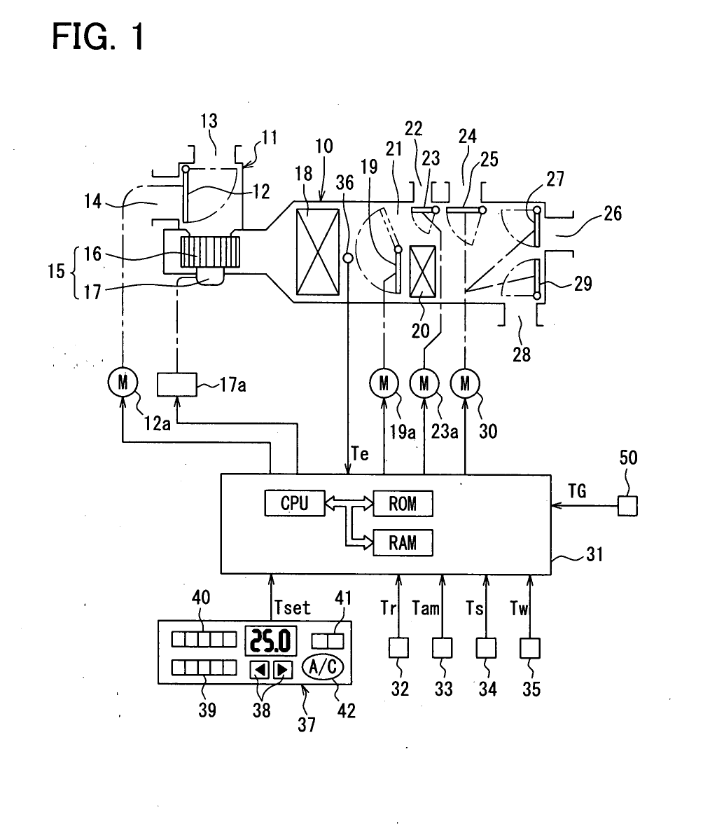

Referring to FIG. 1, first, a ventilation system of an air conditioner for a vehicle will be described. An air conditioning case 10 forms an air passage through which air to be introduced into a passenger compartment of a vehicle flows. An inside/outside air switching device 11 is provided at an upstream position of the air conditioning case 10 with respect to a flow of air. The inside/outside air switching device 11 has an inside/outside air switching door 12 that is operable to open and close an outside air introduction opening 13 and an inside air introduction opening 14. Thus, outside air (i.e., air outside of a passenger compartment) and inside air (i.e., air inside of a passenger compartment) are selectively introduced into the inside/outside air switching device 11. The inside/outside air switching door 12 is, for example, operated by an electric driving device 12a such as a servomotor.

A blower 15 is provided downstream of the inside/outside air switching device 11 for drawing the inside air and the outside air from the inside/outside air switching device 11 and blowing the air into the air conditioning case 10. The blower 15 includes a centrifugal multi-blade fan 16 and a motor 17 for driving the fan 16. A voltage applied to the motor 17, that is, a blower voltage, is controlled by a motor driving circuit 17a so that a rotation speed of the blower 15, that is, an air volume blown by the blower 15 is controlled.

An evaporator (refrigerant evaporator) 18 as a cooling heat exchanger is provided downstream of the blower 15 within the air conditioning case 10. The evaporator 18 performs heat exchange between a low pressure refrigerant, which has been decompressed by a decompressing device of a refrigerating cycle (not shown), and the air blown by the blower 15. Thus, the low pressure refrigerant evaporates by heat of the air, and hence the air is cooled.

An air mix door 19 is provided downstream of the evaporator 18 within the air conditioning case 10. Also, a heater core 20 as a heating heat exchanger is provided downstream of the air mix door 19 within the air conditioning case 10. The heater core 20 heat the air that has passed through the evaporator 18 using heat of a heated fluid such as an engine coolant flowing therein. In the air conditioning case 10, a bypass passage 21 is formed beside the heater core 20, such as on an upper side of the heater core 20, for allowing the air to bypass the heater core 20.

For example, the air mix door 19 is a plate door, and is rotated by an electric driving device 19a such as a servomotor. A position of the air mix door 19, that is, an opening degree of the air mix door 19 is controlled so that a ratio of the volume of the air flowing toward the heater core 20 to be heated to the volume of the cooled air flowing toward the bypass passage 21 is adjusted. Thus, the temperature of air to be introduced into the passenger compartment is controlled by the adjustment of the ratio of heated air to the cooled air.

Namely, in a space defined downstream of the heater core 20, the heated air heated by the heater core 20 and the cooled air passing through the bypass passage 21 are mixed so as to generate the air with a desired temperature. In the present embodiment, the air mix door 19 serves as a device for adjusting the temperature of air to be introduced into the passenger compartment.

The air conditioning case 10 includes an air-blowing mode switching section downstream of the air mixing space in which the heated air and the cooled air are mixed. For example, the air conditioning case 10 has a face opening 26 on its rear upper portion. The face opening 26 is in communication with center face air-blowing outlets 48 and side face air-blowing outlets 49 through face ducts (not shown) for blowing the air toward a passenger's upper body area, such as, an upper area of the passenger compartment.

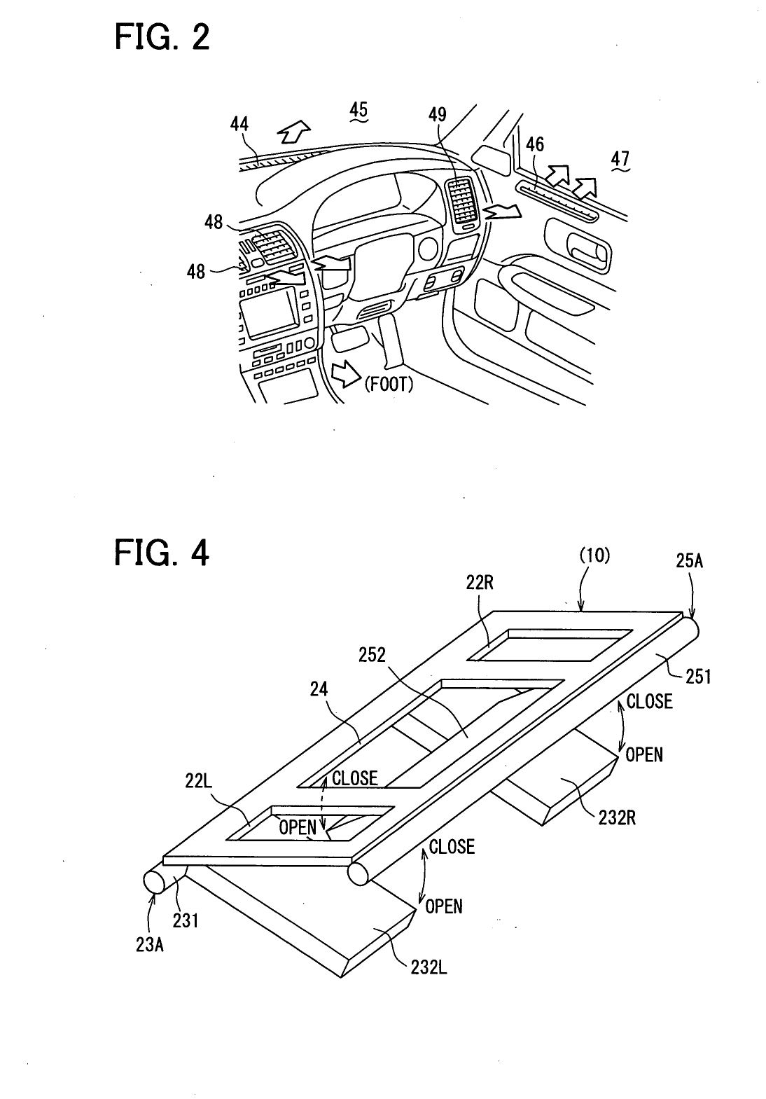

The face air-blowing outlets 48 and the side face air-blowing outlets 49 are, for example, formed on an instrument panel of the vehicle, as shown in FIG. 2. The face opening 26 is opened and closed by a face door 27 as an air-blowing mode door. The face door 27 is, for example, a rotatable plate door.

Further, the air conditioning case 10 has a foot opening 28 under the face opening 26. The foot opening 28 is in communication with foot air-blowing outlets (not shown) through foot ducts (not shown) for blowing the air toward a passenger's foot area, such as a lower area of the passenger compartment. The foot opening 28 is opened and closed by a foot door 29 as an air-blowing mode door. The foot door 29 is, for example, a rotatable plate door.

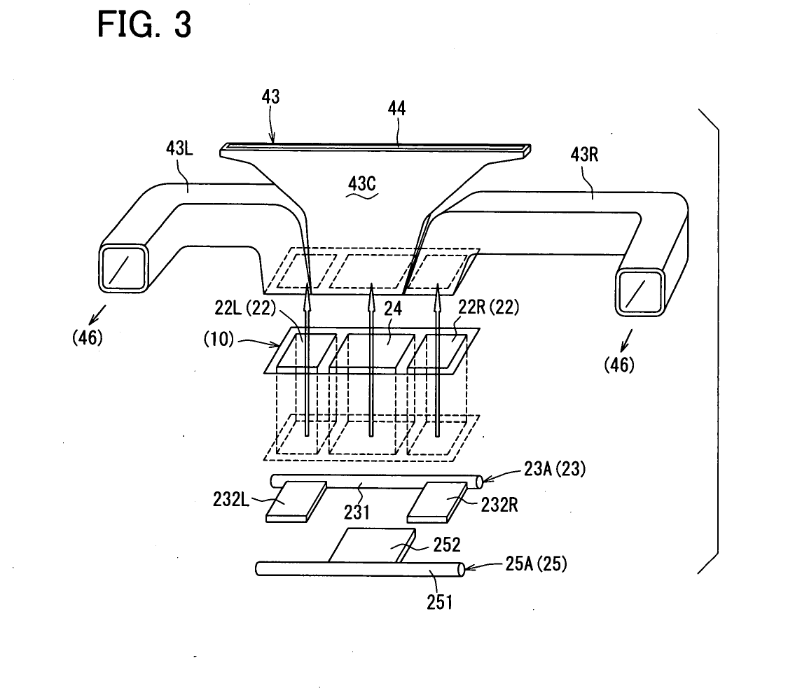

The air conditioning case 10 further includes a defroster opening portion on a top wall thereof. A defroster duct 43 is coupled to the defroster opening portion. The defroster opening portion includes a center defroster opening 24 and side defroster openings 22 such as a right defroster opening 22R and a left defroster opening 22L. As shown in FIG. 3, the center defroster opening 24 is disposed at a middle position with respect to a vehicle right and left direction. The right defroster opening 22R is disposed on a right side of the center defroster opening 24 and the left defroster opening 22L is disposed on a left side of the center defroster opening 24. That is, the side defroster openings 22 are disposed separately on opposite sides of the center defroster opening 24.

The defroster duct 43 includes a center defroster duct portion 43C, a right defroster duct portion 43R and a left defroster duct portion 43L. The center defroster opening 24 is in communication with a center defroster air-blowing outlet 44 through the center defroster duct portion 43C for blowing the air toward an inner surface of a front windshield 45 of the vehicle from the center defroster air-blowing outlet 44. The right defroster opening 22R is in communication with a side defroster air-blowing opening 46 through the right defroster duct portion 43R for blowing the air toward an inner surface of a right side window glass of the vehicle from the side defroster air-blowing opening 46.

Likewise, the left defroster opening 22L is in communication with an opposite side defroster air-blowing opening 46 through the left defroster duct portion 43L for blowing the air toward an inner surface of a left side window glass from the opposite side defroster air-blowing opening 46. The side defroster air-blowing outlets 46 are, for example, disposed at inner upper portions of side doors of the vehicle. The center defroster air-blowing outlet 44 is, for example, disposed adjacent to a lower potion of the windshield 45.

The center defroster opening 24 and the side defroster openings 22 are opened and closed by a center defroster door device 25 and a side defroster door device 23 as air-blowing mode doors, respectively. Specifically, as shown in FIGS. 3 and 4, the center defroster door device 25 includes a center defroster door 25A, which is a rotatable plate door. The side defroster door device 23 includes a side defroster door 23A, which is a rotatable plate door.

The center defroster door 25A has a rotation shaft 251 and a plate-shaped door body 252 for opening and closing the center defroster opening 24. The door body 252 extends from a substantially middle position of the rotation shaft 251. The side defroster door 23A includes a rotation shaft 231, a plate-shaped right door body 232R and a plate-shaped left door body 232L for opening and closing the side defroster openings 22R, 22L. The right and left door bodies 232R, 232L extend from the rotation shaft 231 and are spaced from each other by a predetermined distance in a longitudinal direction of the rotation shaft 231. The right and left door bodies 232R, 232L are integrated through the rotation shaft 231. Thus, the right and left door bodies 232R, 232L are integrally rotatable.

Alternatively, the side defroster door 23 may be separated into a right defroster door including the right door body 232R and a left defroster door including the left door body 232L so that the right and left door bodies 232R, 232L can be operated separately. In the example shown in FIG. 4, both of the side defroster door 23A and the center defroster door 25A are disposed under the side defroster openings 22L, 22R and the center defroster opening 24. Alternatively, the side defroster door 23A and the center defroster door 25A may be disposed above the side defroster openings 22L, 22R and the center defroster opening 24. Further, one of the side defroster door 23A and the center defroster door 25A may be disposed above the side defroster openings 22L, 22R and the center defroster opening 24, and the other may be disposed under the side defroster openings 22L, 22R and the center defroster opening 24.

Namely, the side defroster openings 22L, 22R and the center defroster opening 24 can be disposed either inside of the air conditioning case 10 to be capable of contacting inner surfaces of a case wall that defines the side defroster openings 22L, 22R and the center defroster opening 24 or outside of the air conditioning case 10 to be capable of contacting outer surfaces of the case wall. That is, arrangements of the center defroster door 25A and the side defroster door 23A are not limited to the illustrated example. Also, arrangements of the rotation shafts 231, 251 are not limited to the illustrated example, but may be modified in various ways.

As shown in FIG. 1, the center defroster door 25A, the face door 27 and the foot door 29 are connected to a linking device (not shown) and operated by an electric driving device 30 such as a servomotor through the linking device. The side defroster door 23A is operated by an electric driving device 23a such as a servomotor. Namely, the side defroster door 23A is operated separately from the center defroster door 25A, the face door 27 and the foot door 29.

Next, an electric control system of the air conditioner will be described with reference to FIG. 1. The air conditioner control unit 31 (hereafter, the a/c control unit 31) is constructed of a well-known microcomputer including a CPU, a ROM, a RAM and the like and peripheral circuits thereof. The a/c control unit 31 receives sensor signals from sensors such as an inside air temperature sensor 32, an outside air temperature sensor 33, a solar radiation sensor 34, a heated fluid temperature sensor 35, an evaporator air temperature sensor 36, a glass temperature sensor 50 and the like. Also, the a/c control unit 31 receives manipulation signals from switches of an air conditioner control panel 37.

The inside air temperature sensor 32 detects an inside air temperature Tr. The outside air temperature sensor 33 detects an outside air temperature Tam. The solar radiation sensor 34 detects the amount of solar radiation Ts. The heated fluid temperature sensor 35 detects the temperature Tw of the heated fluid. The evaporator air temperature sensor 36 detects the temperature of the air downstream of the evaporator 18 with respect to the flow of the air. Further, the glass temperature sensor 50 detects the temperature TG of the widow glass such as the windshield 45 and/or the side window glass 47.

Here, the glass temperature sensor 50 may be any type of sensor. For example, the temperature of the window glass may be directly or indirectly detected. As examples of the direct detection, the glass temperature may be detected in a contact manner or in a non-contact manner. As an example of the indirect detection, the glass temperature may be estimated based on based on factors such as the outside air temperature and a vehicle speed.

The air conditioner control panel 37 is, for example, mounted adjacent to the instrument panel of the vehicle. The air conditioner operation panel 37 has various switches such as a temperature setting switch 38, an air volume switch 39, an air-blowing mode switch 40, an inside/outside air switch 41, an air conditioner switch 42, and the like. The switches 38 to 42 are operable by a user.

The temperature setting switch 38 is configured to generate a signal Tse indicative of a temperature set by a user. The air volume switch 39 is configured to generate a signal indicative of switching of the volume of air such as a blower level. The air-blowing mode switch 40 is configured to generate a signal indicative of an air blowing mode. The inside/outside air switch 41 is configured to generate a signal indicative of switching of an inside air mode and an outside air mode. The air conditioner switch 42 is configured to generate an on/off signal of a compressor (not shown), that is, a refrigerant compressor for the air conditioner.

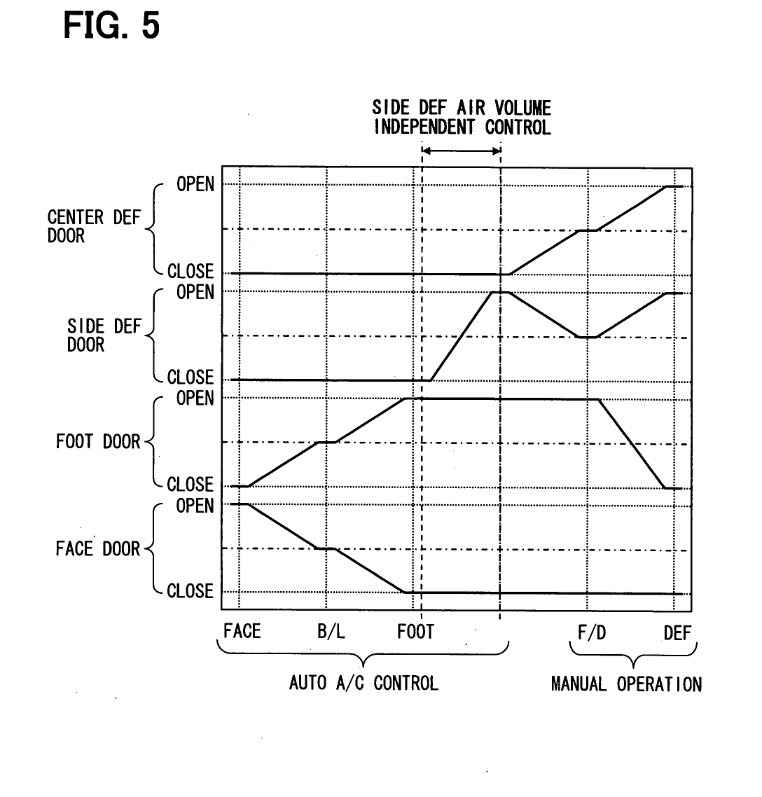

Next, operation characteristics of air-blowing mode doors such as the center defroster door 25A, the side defroster door 23A, the foot door 29 and the face door 27 relative to air-blowing modes will be described with reference to FIG. 5. In FIG. 5, a horizontal axis denotes the air-blowing modes, and a vertical axis denotes opening degrees (e.g., close=0%, open=100%) of the air-blowing mode doors 23A, 25A, 27, 29.

Regarding the air-blowing modes, a face mode, a bi-level mode (B/L), a foot mode and a side defroster air volume independent control range (mode) are included in an automatic air conditioning control region. A foot and defroster mode (F/D) and a defroster mode (DEF) are included in a manual operation region.

In the face mode, the face door 27 is fully opened, and the center defroster door 25A, the side defroster door 23A and the foot door 29 are fully closed. Thus, the air blown by the blower 15 passes through the face opening 26 and is blown toward the passenger's upper body area from the center face air-blowing outlets 48 and the side face air-blowing outlets 49. In this case, a cooling operation is typically performed.

In the bi-level mode, the face door 27 and the foot door 29 are substantially half-opened (i.e., the opening degrees thereof are about 50%). The center defroster door 25A and the side defroster door 23A are closed. In this condition, the air mix door 19 is operated to a middle position between a maximum cooling position where the passage to the heater core 20 is fully closed and a maximum heating position where the bypass passage 21 is fully closed. Thus, the cooled air passing through the bypass passage 21 mainly flows toward the face opening 26, and the heated air heated by the heater core 20 mainly flows toward the foot opening 28.

As such, the temperature of air passing through the face opening 26 is lower than the temperature of air passing through the foot opening 28. As a result, the temperature of air blown toward the passenger's upper body area is lower than the temperature of air blown toward the passenger's foot area. Namely, a temperature distribution of a head cool and foot hot type, which is comfortable to passengers, is created in the bi-level mode.

In the foot mode, the foot door 29 is fully opened. The center defroster door 25A, the side defroster door 23A and the face door 27 are fully closed. Thus, the air blown by the blower 15 passes through the foot opening 28 and is blown toward the passenger's foot area from the foot air-blowing outlets (not shown). In this case, a heating operation is typically performed.

Regarding the side defroster air volume independent control range, a control operation in which the opening degrees of the side defroster door 23A and the center defroster door 25A are independently controlled is performed. Specifically, when the glass temperature TG detected by the glass temperature sensor 50 reduces lower than a predetermined temperature in the foot mode, the opening degree of the side defroster door 23A is increased while the center defroster door 25A is maintained in the closed position according to a cold degree of the glass temperature TG.

As such, the heated air flows into the side defroster duct portions 43R, 43L from the right and left defroster openings 22R, 22L and is blown toward the side window glasses 47 from the side defroster air-blowing outlets 46. Therefore, the cold draft due to the chilled side window glasses 47 is reduced or swept. It is less likely that passengers will feel cool such as in their shoulders, backs and knees. As such, a heating operation, which is comfortable to passengers, is performed.

In this case, the volume of air blown by the blower 15 is controlled such that the volume of air blown from the foot air-blowing outlets is not varied due to the change of the volume of air blown from the side defroster air-blowing outlets 46. That is, the volume of air blown by the blower 15 is controlled in accordance with the change of the volume of air blown from the side defroster air-blowing outlets 46 so that the volume of air blown from the foot air-blowing outlets is maintained. Therefore, it is less likely that passengers will feel cool or hot in their foot in the side defroster air volume independent control mode.

When the foot and defroster mode is manually selected, the center defroster door 25A and the side defroster door 23A are operated to substantially half-opened positions while maintaining the foot door 29 in the opened position. Thus, the air is blown toward the windshield 45, the side window glasses 47 and the passenger's foot area from the center defroster air-blowing outlet 44, the side defroster air-blowing outlets 46 and the foot air-blowing outlets, respectively. Namely, an anti-fog operation for restricting the window glasses 45, 47 from being fogged and the heating operation are simultaneously performed.

In general, when it is required to immediately remove or restrict the fog of the window glasses 45, 47, the defroster mode is manually selected. When the defroster mode is manually selected, the center defroster door 25A and the side defroster door 23A are fully opened. The foot door 29 and the face door 27 are closed. As such, the air is blown toward the windshield 45 and the side window glasses 47 from the center defroster air-blowing outlets 44 and the side defroster air-blowing outlets 46, respectively. Accordingly, the anti-fog operation of the window glasses 45, 47 is performed.

In the present embodiment, the volume of air blown from the side defroster air-blowing outlets 46 can be adjusted by a defroster air volume adjusting unit. Therefore, the cold draft due to the chilled side window glasses 47 is effectively reduced.

The defroster air volume adjusting unit is provided by the center defroster door 25A and the side defroster door 23A so that the volume of air blown from the side defroster air-blowing outlets 46 is controlled separately from the volume of air blown from the center defroster air-blowing outlet 44. Since the center defroster door 25A and the side defroster door 23A are provided separately and disposed to open and close the respective openings 24, 22R, 22L, the defroster air volume adjusting unit is easily and simply constructed.

The side defroster door device 23 is constructed of the plate door 23A rotatable about the rotation axis 231. That is, the side defroster door 23A is provided by a simple door mechanism. Further, the volume of air blown from the side defroster air-blowing outlets 46 is adjusted according to the glass temperature TG detected by the glass temperature sensor 50.

Namely, the decrease of the glass temperature, which causes the cold draft, can be detected, and the volume of air blown from the side defroster air-blowing outlets 46 can be adjusted according to the decrease of the glass temperature. Therefore, the cold draft from the side window glasses 47 is effectively reduced.

Further, the volume of air blown by the blower 15 is adjusted in accordance with the adjustment of the volume of air blown from the side defroster air-blowing outlets 46. Therefore, the volume of air blown from another air-blowing outlets such as the foot air-blowing outlets can be maintained, irrespective of the adjustment of the volume of air blown from the side defroster air-blowing outlets 46. Accordingly, it is less likely that passengers will feel cool or hot in their foot due to the change of the volume of air blown from the side defroster air-blowing outlets 46.

### Second Embodiment

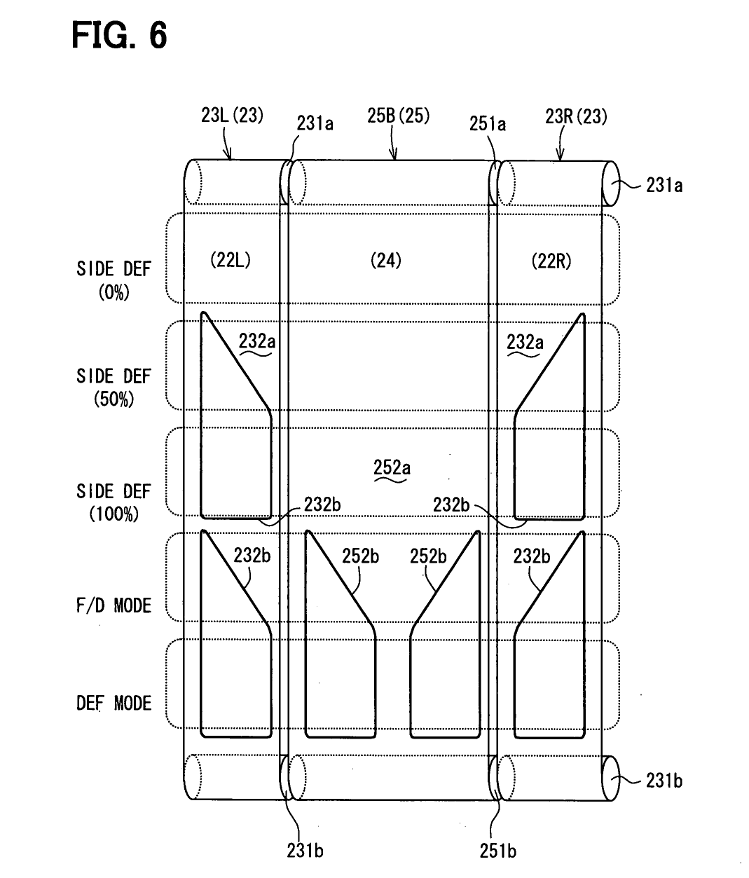

In the air conditioner of the second embodiment, as shown in FIG. 6, the center defroster door device 25 and the side defroster door device 23 are constructed of a slide-type center defroster door 25B and right and left slide-type side defroster doors 23R, 23L, respectively, instead of the plate-type center defroster door 25A and the plate-type side defroster door 23A of the first embodiment.

The center defroster door 25B has a slidable door body 252a and rotation shafts 251a, 251b. The rotation shafts 251a, 251b are disposed at opposite ends of the slidable door body 252a to wind the door body 252a. The door body 252a is, for example, made of a resinous film, and is formed with openings 252b at predetermined positions.

The side defroster door device 23 includes the right side defroster door 23R and the left side defroster door 23L. Each of the right and left side defroster doors 23R, 23L includes a slidable door body 232a and rotation shafts 231a, 231b. The rotation shafts 231a, 231b are disposed at opposite ends of the slidable door body 232a to wind the door body 232a. The door body 232a is, for example, made of a resin film, and is formed with openings 232b at predetermined positions.

Next, the air-blowing modes will be described with reference to FIG. 6. The face mode, the bi-level mode and the foot mode are performed similar to those of the first embodiment. When the glass temperature detected by the glass temperature sensor 50 reduces lower than the predetermined temperature in the foot mode, the side defroster air volume independent control operation is performed. In this case, the opening degrees of the side defroster doors 23R, 23L and the opening degree of the center defroster door 25B are increased according to the cold degree of the glass temperature.

For example, the door bodies 232a of the side defroster doors 23R, 23L are slid so that the openings 232b are moved with respect to the side defroster openings 22R, 22L. As such, the opening degrees of the side defroster openings 22R, 22L by the openings 232b, that is, degrees of overlap of the openings 232b with the side defroster openings 22R, 22L are varied. Likewise, the door body 252a of the center defroster door 25B is slid so that the openings 252b are moved with respect to the center defroster opening 24. As such, the opening degree of the center defroster opening 24 by the openings 252b, that is, a degree of overlap of the openings 252b with the center defroster opening 24 is varied.

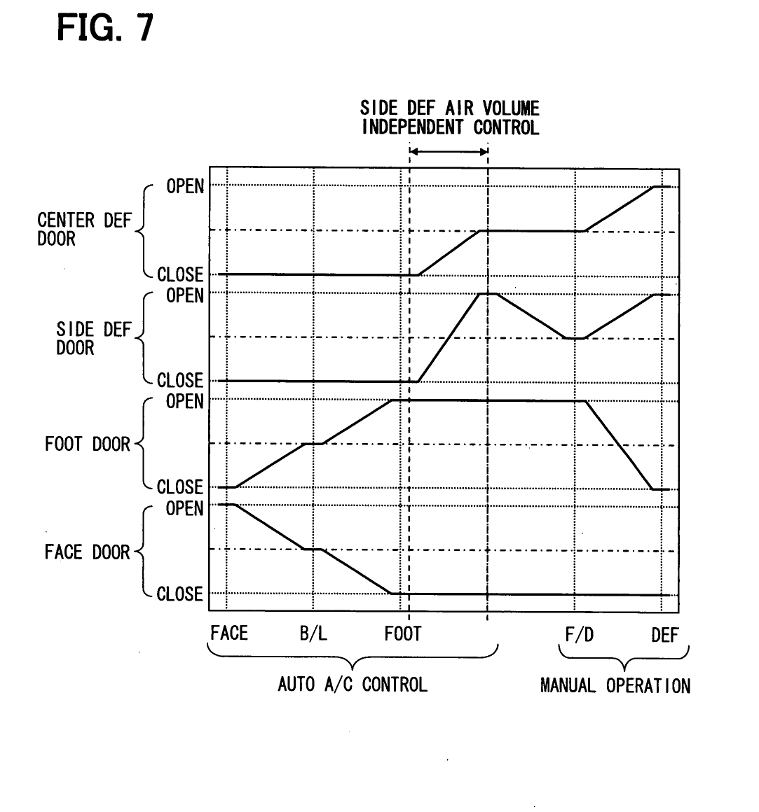

Next, operation characteristics of the center defroster door 25B, the side defroster doors 23R, 23L, the foot door 29 and the face door 27 relative to air-blowing modes will be described with reference to FIG. 7. In the face mode, the bi-level mode, and the foot mode, the opening degrees of the center defroster door 25B, the side defroster doors 23R, 23L, the foot door 29 and the face door 27 are controlled in the manner similar to the first embodiment shown in FIG. 5.

In the first embodiment shown in FIG. 5, the center defroster door 25A is in the fully closed position in the side defroster independent air volume control operation. In the second embodiment shown in FIG. 7, on the other hand, the opening degree of the center defroster door 25B is varied between 0% and substantially 50% in the side defroster air volume independent control operation in order to reduce cold draft due to the cold front windshield 45. In this case, the opening degree of the center defroster door 25B is varied between 0% and 50% by sliding the openings 252b of the door body 252a with respect to the center defroster opening 24. The opening degrees of the side defroster doors 23R, 23L are also varied between 0% and 100% in the side defroster air volume independent control operation.

Accordingly, in addition to the heated air from the foot air-blowing outlets, the air is blown toward the side window glasses 47 and the front windshield 45 from the side defroster air-blowing outlets 46 and the center defroster air-blowing outlet 44, respectively, in the side defroster air volume independent control mode. Therefore, the cold draft due to the front windshield 45 is effectively reduced while reducing the cold draft due to the side window glasses 47. It is less likely that passengers will feel cool such as in their shoulders, backs and knees. Accordingly, the heating operation, which is comfortable for passengers, is performed.

When the foot and defroster mode is manually selected, the center defroster door 25B and the side defroster doors 23R, 23L are operated to the substantially half-opened positions while maintaining the foot door 29 in the fully opened position. When the fog of the window glasses 45, 47 needs to be immediately removed, the defroster mode will be manually selected. When the defroster mode is manually selected, the center defroster door 25B and the side defroster door 23R, 23L are operated to the fully opened positions, and the foot door 29 and the face door 27 are operated to the fully closed positions, similar to the first embodiment.

In the present embodiment, the defroster air volume adjusting unit is constructed of the center defroster door 25B and the right and left side defroster doors 23R, 23L. Therefore, the volumes of air blown from the side defroster air-blowing outlets 46 can be adjusted separately from the volume of air blown from the center defroster air-blowing outlet 44.

In addition, since the side defroster door device 23 is constructed of the right defroster door 23R and the left defroster door 23L, the volume of air blown from the right defroster air-blowing outlet and the volume of air blown from the left defroster air-blowing outlet can be separately adjusted. Namely, the side defroster air volume independent control operation is performed separately for a right seat and a left seat. Also, the right and left defroster doors 23R, 23L are composed of slide doors. Therefore, the spaces for the right and left defroster doors 23R, 23L are reduced.

In addition to the adjustment of the volume of air blown from the side defroster air-blowing outlets 46, the volume of air blown from the center defroster air-blowing outlet 44 is adjusted according to the glass temperature detected by the glass temperature sensor 50. Namely, the volume of air blown from the center defroster air-blowing outlet 44 is adjusted according to the degree of reduction of the glass temperature. Therefore, the cold draft due to the front windshield 45 is effectively reduced.

Further, the volume of air blown by the blower 15 is controlled according to the adjustment of the volume of air blown from the side defroster air-blowing outlets 46 and/or the center defroster air-blowing outlet 44 so that the volumes of air blown from the other air-blowing outlets such as the foot air-blowing outlets can be maintained. For example, the volume of air blown from the foot air-blowing outlets is not affected by the adjustment of the volume of air blown from the side defroster air-blowing outlets 46 and the center defroster air-blowing outlet 44. Therefore, it is less likely that passenger will feel uncomfortable such as cool or hot due to the defroster air volume independent control operation.

In the defroster air volume independent control operation of the present embodiment, since the air is blown from the center defroster air-blowing outlet 44 in addition to the side defroster air-blowing outlets 46, it is less likely that the windshield 45 will be fogged and passengers will feel uncomfortable in their face areas due to the change of the volume of air blown from the side defroster air-blowing outlets 46.

### Third Embodiment

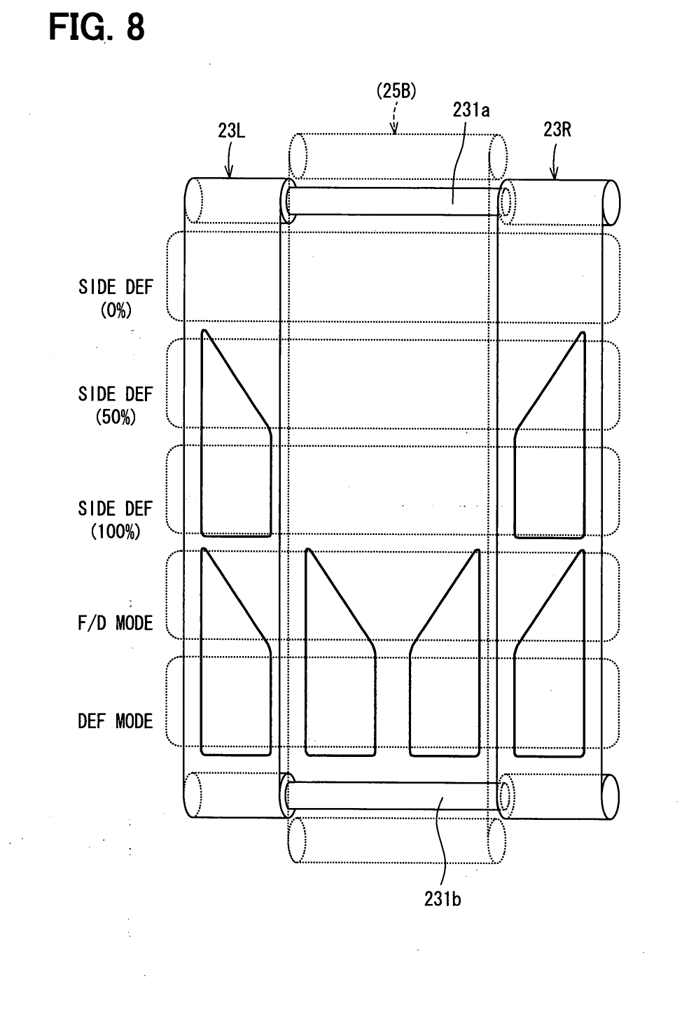

In the air conditioner of the third embodiment, the center defroster door device 25 and the side defroster door device 23 are constructed of the slide-type center defroster door 25B and the slide-type side defroster doors 23L, 23R, similar to the second embodiment. In addition, as shown in FIG. 8, the right defroster door 23R and the left defroster door 23L are integrally movable.

For example, the right defroster door 23R and the left defroster door 23L share the rotation shafts 231a, 231b. Alternatively, the rotation shafts 231a, 23b of the right defroster door 23R can be connected to the rotation shafts 231a, 231b of the left defroster door 23L. The right defroster door 23R and the left defroster door 23L may be integrated by another way. The right and left defroster door 23R, 23L are operated in the similar manner as the second embodiment. The opening degree of the side defroster openings 22R, 22L are controlled by the right and left defroster door 23R, 23L in the similar manner as shown in FIG. 5 or 7.

In the present embodiment, the structure and a driving mechanism of the side defroster door 23 is simplified, as compared with that of the second embodiment. Also, a control device of the side defroster door 23 is simplified.

### Fourth Embodiment

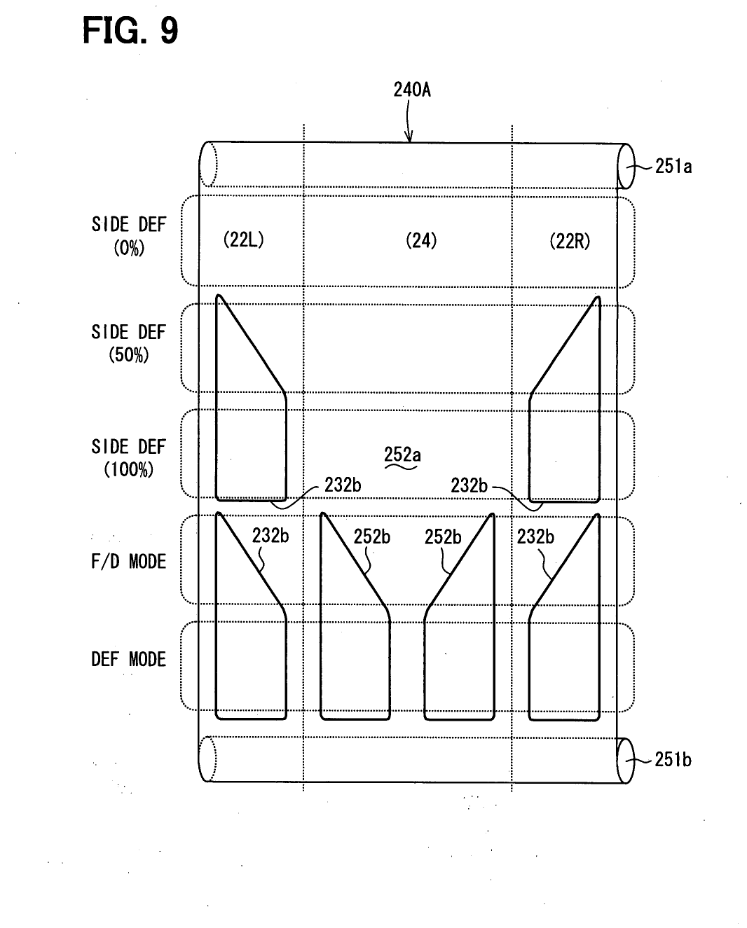

The air conditioner of the fourth embodiment has a defroster slide door 240A instead of the center defroster door device 25 and the side defroster door device 23, as shown in FIG. 9. Namely, the center defroster door device 25 and the side defroster door device 23 are integrated into the defroster slide door 240A.

As shown in FIG. 9, the defroster slide door 240A includes the slide door body 252a and the rotation shafts 251a, 251b at the opposite ends of the slide door body 252a to wind the slide door body 252a. The slide door body 252a is formed with the opening 252b for the center defroster opening 24 and the openings 232b for the side defroster openings 22R, 22L at predetermined positions. The defroster slide door 240A is operated such that the openings 252b, 232b are slid with respect to the defroster openings 24, 22R, 22L in the similar manner as the second embodiment. The opening degrees of the side defroster openings 22R, 22L and the center defroster opening 24 can be controlled by the openings 232b, 252b in the similar manner shown in FIG. 5 or 7.

In the present embodiment, the defroster slide door 240A have further simple driving structure and is compact.

### Fifth Embodiment

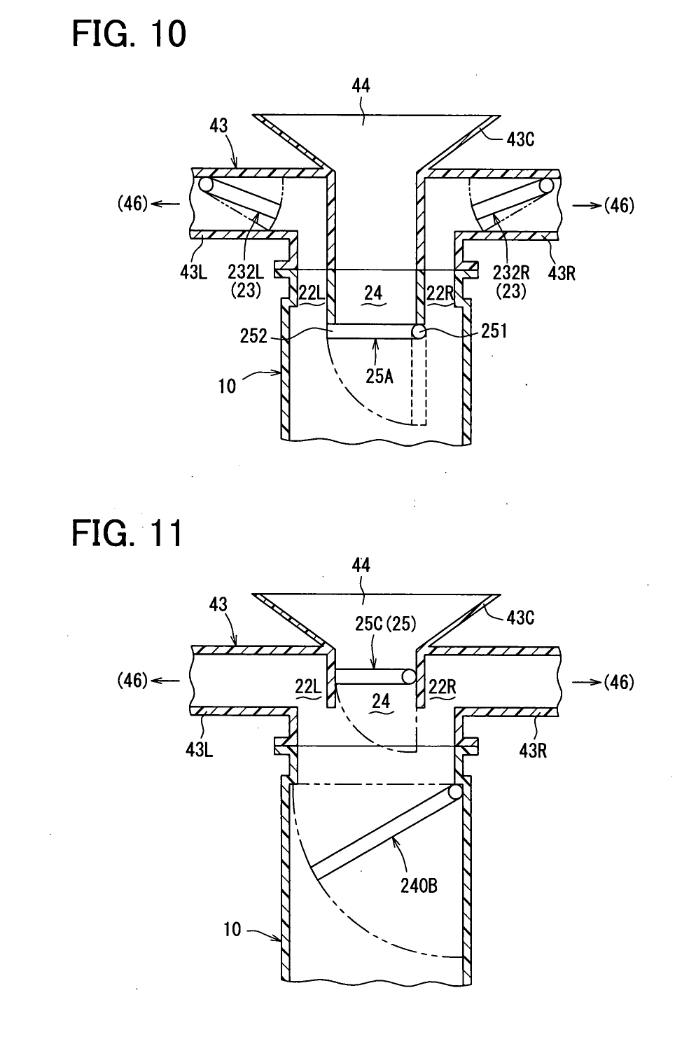

The air conditioner of the fifth embodiment has a defroster section having a structure different from that of the first embodiment. As shown in FIG. 10, the side defroster door device 23 includes a right defroster door 232R and a left defroster door 232L. The right defroster door 232R is disposed inside of the right defroster duct portion 43R that connects the right defroster opening 22R and the right defroster air-blowing outlet 46. The left defroster door 232L is disposed inside of the left defroster duct portion 43L that connects the left defroster opening 22L and the left defroster air-blowing outlet 46.

That is, it is not always necessary to arrange the side defroster door device 23 within the air conditioning case 10 as shown in the example of FIG. 4. The side defroster doors 232R, 232L can be disposed in any locations such as within the side defroster duct portion 43R, 43L.

In the example of FIG. 10, the center defroster door 25A is disposed inside of the air conditioner case 10. However, the position of the center defroster door 25A may be modified. In the present embodiment, the side defroster doors 232R, 232L and the center defroster door 25A can be operated in the similar manner as in FIG. 5 or 7.

### Sixth Embodiment

The air conditioner of the sixth embodiment has a defroster section having a structure different from that of the first embodiment, as shown in FIG. 11. In the present embodiment, the defroster air volume adjusting unit is constructed of a side-center defroster door (first defroster door) 240B and a center defroster door (second defroster door) 25C. The side-center defroster door 240B is disposed to control the total volume of air blown from the side and center defroster air-blowing outlets 44, 46. The center defroster door 25C is disposed downstream of the side-center defroster door 240B to control the volume of air blown from the center defroster air-blowing outlet 44. Also in this case, the defroster air volume adjusting unit is constructed by a simple structure.

In the example illustrated in FIG. 11, the side-center defroster door 240B is disposed inside of the air conditioning case 10, and the center defroster door 25C is disposed in the center defroster duct portion 43C of the defroster duct 43. That is, it is not always necessary to locate the center defroster door 25 within the air conditioning case 10.

In the present embodiment, the side-center defroster door 240B and the center defroster door 25C can be operated such that the volumes of air blown from the center defroster air-blowing outlet 44 and the side defroster air-blowing outlets 46 are adjusted in the similar manner as in FIG. 5 or 7.

### Seventh Embodiment

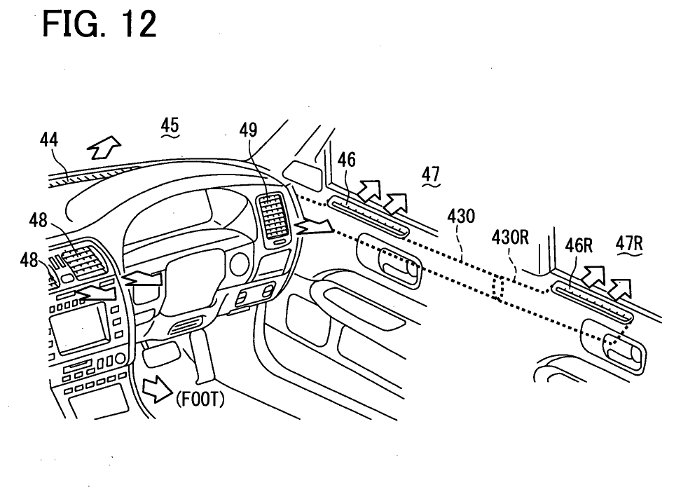

In the air conditioner of the seventh embodiment, the side defroster duct portions 43R, 43L that respectively connect the side defroster openings 22R, 22L and the side defroster air-blowing outlets 46 are extended toward rear side doors, as shown in FIG. 12.

For example, a front seat door duct 430 is disposed along an upper portion of a front door and a rear seat door duct 430R is disposed along an upper portion of a rear door. The rear seat door duct 430R is in communication with the front seat door duct 430. The front seat door duct 430 is in communication with the side defroster air-blowing outlet 46 for blowing the air toward the front side window 47. The rear door duct 430R is in communication with a rear seat side defroster air-blowing outlet 46R for blowing the air flowing from the front seat door duct 430 toward a rear side window 47R.

As such, in addition to the reduction of the cold draft duet to the windshield 45 and/or the front side window glasses 47, cold draft due to the rear side window 47R can be reduced.

### Modifications

In the above embodiments, the volume of air blown from the side defroster air-blowing outlets 46 is automatically controlled. Alternatively, it can be configured such that the volume of air blown from the side defroster air-blowing outlets 46 is manually controlled. In other words, the side defroster independent control mode may be manually selected.

In the second embodiment, the side defroster air volume independent control operation is performed by the slide doors 25B, 23L, 23R. However, the side defroster independent air volume control operation shown in FIG. 7 may be performed by any other doors such as plate doors.

In the above embodiments, when the side defroster door device 23 is constructed of the right side defroster door and the left side defroster door, which are separately operable, the volume of air blown from the right side defroster air-blowing, outlet and the volume of air blown from the left side defroster air-blowing outlet may be controlled separately according to occupancy of a right seat and a left seat.

Additional advantages and modifications will readily occur to those skilled in the art. The invention in its broader term is therefore not limited to the specific details, representative apparatus, and illustrative examples shown and described.

What is claimed is:

1. An air conditioner for a vehicle, comprising:
a blower for generating a flow of air;
a center defroster air-blowing outlet for blowing the air toward the windshield;
a side defroster air-blowing outlet for blowing the air toward the side window glass; and
a defroster air volume adjusting unit disposed to adjust a volume of air blown from the center defroster air-blowing outlet and a volume of air blown from the side defroster air-blowing outlet.

2. The air conditioner according to claim 1, wherein
the defroster air volume adjusting unit includes a center defroster door device and a side defroster door device,
the center defroster door device is disposed to adjust the volume of air blown from the center defroster air-blowing outlet, and
the side defroster door device is disposed to adjust the volume of air blown from the side defroster air-blowing outlet.

3. The air conditioner according to claim 2, further comprising:
an air conditioning unit having a defroster opening portion that allows the air blown by the blower to pass through; and
a defroster duct disposed to communicate the defroster opening portion with the center defroster air-blowing outlet and the side defroster air-blowing outlet, wherein
the side defroster door device is disposed within the defroster duct.

4. The air conditioner according to claim 2, wherein
the side defroster door device includes a right door and a left door.

5. The air conditioner according to claim 4, wherein
the right door and the left door are disposed to be integrally movable.

6. The air conditioner according to claim 5, wherein
the right door includes a right rotation shaft, the left door includes a left rotation shaft, and
the right rotation shaft is integrated with the left rotation shaft.

7. The air conditioner according to claim 2, wherein
the side defroster door device is constructed of a rotatable door that is rotatable about a rotation axis.

8. The air conditioner according to claim 2, wherein
the side defroster door device is constructed of a slide door.

9. The air conditioner according to claim 8, wherein
the center defroster door device and the side defroster door device are integrated into a defroster slide door.

10. The air conditioner according to claim 1, wherein
the defroster air volume adjusting unit includes a first defroster door and a second defroster door,
the first defroster door is disposed to adjust a total volume of the air blown from the center defroster air-blowing outlet and the air blown from the side defroster air-blowing outlet, and
the second defroster door is disposed downstream of the first defroster door to adjust the volume of air blown from the center defroster air-blowing outlet.

11. The air conditioner according to claim 10, further comprising:
an air conditioning unit including a defroster opening portion that allows the air blown by the blower to pass through;
a defroster duct disposed to communicate the defroster opening portion with the center defroster air-blowing outlet and the side defroster air-blowing outlet, wherein
the second defroster door is disposed within the defroster duct.

12. The air conditioner according to claim 1, wherein
the side defroster air-blowing outlet is a front side defroster air-blowing outlet disposed adjacent to a front side window glass of the vehicle, the air conditioner further comprising:
an air conditioning unit including a defroster opening portion that allows the air blown by the blower to pass through;
a rear side defroster air-blowing outlet disposed adjacent to a rear side window glass of the vehicle for blowing the air toward the rear side window glass; and
a defroster duct disposed to communicate the defroster opening portion with the center defroster air-blowing outlet, the front side defroster air-blowing outlet and the rear side defroster air-blowing outlet.

13. The air conditioner according to claim 1, further comprising:
a glass temperature detecting unit disposed to detect a temperature of at least one of the windshield and the side window glass, wherein
the defroster air volume adjusting unit is operable to adjust the volume of air blown from the side defroster air-blowing outlet according to the temperature detected by the glass temperature detecting unit.

14. The air conditioner according to claim 13, wherein
the defroster air volume adjusting unit is operable to adjust the volume of air blown from the center defroster air-blowing outlet according to the detected temperature.

15. The air conditioner according to claim 13, wherein
the blower is controlled such that a volume of air generated by the blower is adjusted according to an adjustment of the volume of air blown from the side defroster air-blowing outlet.

16. The air conditioner according to claim 2, further comprising:
a glass temperature detecting unit disposed to detect a temperature of at least one of the windshield and the side window glass, wherein
when the temperature detected by the glass temperature detecting unit is lower than a predetermined temperature, the center defroster door device is operated to a closed position so that the air is restricted from passing through the center defroster air-blowing outlet and the side defroster door device is operated to an opened position so that the air is allowed to pass through the side defroster air-blowing outlet.

17. An air conditioner for a vehicle, comprising:
a blower for generating a flow of air;
an air conditioning case defining an air passage through which the air generated by the blower flows, the air conditioning case including a defroster opening portion that allows the air to pass through;
a center defroster air-blowing outlet disposed adjacent to a windshield of the vehicle for blowing the air passing through the defroster opening portion toward the windshield;
a side defroster air-blowing outlet disposed adjacent to a side window glass of the vehicle for blowing the air passing through the defroster opening portion toward the side window glass;
a defroster duct coupled to the defroster opening portion, the defroster duct including a center defroster passage portion that allows communication between the defroster opening portion and the center defroster air-blowing outlet and a side defroster passage portion that allows communication between the defroster opening portion and the side defroster air-bowing outlet; and
a defroster air volume adjusting unit configured to adjust a volume of air passing through the center defroster passage portion separately from a volume of air passing through the side defroster passage portion.

18. The air conditioner according to claim 17, wherein
the defroster air volume adjusting unit includes a center defroster door device and a side defroster door device,
the center defroster door device is operable to adjust the volume of air passing through the center defroster passage portion, and
the side defroster door device is operable to adjust the volume of air passing through the side defroster passage portion separately from the center defroster door device.

19. The air conditioner according to claim 18, further comprising:
a glass temperature detecting unit for detecting a temperature of at least one of the windshield and the side window glass, wherein
when the temperature detected by the glass temperature detecting unit is lower than a predetermined temperature, the center defroster door device and the side defroster door device are separately operated according to the detected temperature.

20. The air conditioner according to claim 18, wherein
the defroster opening portion includes a center defroster opening that is in communication with the center defroster passage portion and a side defroster opening that is in communication with the side defroster passage portion,
the center defroster door device is disposed to open and close the center defroster opening, and
the side defroster door device is disposed to open and close the side defroster opening.
